(19) United States
(12) Patent Application Publication
(10) Pub. No.: US 2010/0105473 A1
(43) Pub. Date: Apr. 29, 2010

(54) Video role play

(76) Inventor: Christopher Murphy, Marlboro, NJ (US)

Correspondence Address: GEARHART LAW, LLC, 4 FERNDALE ROAD, CHATHAM, NJ, 07928, US

(21) Appl. No.: 12/589,590

(22) Filed: Oct. 26, 2009

Related U.S. Application Data
(60) Provisional application No. 61/108,587, filed on Oct. 27, 2008.

(51) Int. Cl. A63F 13/00; A63F 9/24

(52) U.S. Cl. 463/30; 463/44

(57) ABSTRACT

The present invention relates to an entertainment system, in particular to a role-play video game for one, or two or more players where game software accesses a machine readable media to obtain a set of preselected media clips. These media clips may be scenes from a movie, a television show or a theatre play. The game then serves the chosen media clip to a display device, and plays the audio track assigned to the media clip on a sound generating device. The sound generating device can be engaged or disabled at will. Multiple categories and sub-categories are used by the game software for sorting the media clips. These categories are represented by plurality multi-layered menus that are used to isolate the most desirable media clip for a user. Before a role play begins, a counter gives a user a chance to prepare emotionally and mentally for the ensuing role play. A user may view the subtitles during a role play session for assistance with the same.

### CLAIM OF PRIORITY

This application claims the benefit of a U.S. Patent Provisional application Ser. No. 61/108,587, filed on Oct. 27, 2008, the contents of which are fully incorporated herein by reference.

### FIELD OF THE INVENTION

The invention relates to an entertainment system, in particular, a role play game for acting out scenes from memorable movies, theater, television or radio playing on a display screen.

### BACKGROUND OF THE INVENTION

Film recording has given humanity an accessible, affordable and rewarding form of entertainment. With seemingly little effort, films present a compelling drama, an insightful documentary or a delightful comedy. The same is true whenever acting and story telling is combined with visual presentation, such as in a motion picture, on television or on theatre stage. People tend to easily absorb, recall, and react positively to information presented aurally and visually. Visual information is currently used as a tool to diffuse tension, to find insight or to vicariously experience that which the viewer cannot realistically experience on his or her own. The present invention lets viewers magnify and revisit the positive emotions that users get from watching motion pictures, by enabling them to act out some of the most memorable or notable scenes from movies, theater, television or radio.

Known prior art role playing games or movieoke devices include U.S. Patent Application No. 2008/0168350; U.S. Pat. No. 7,228,273; and U.S. Pat. No. 5,752,883.

U.S. Patent Application No. 2008/0168350 discloses a user's recorded voice and/or image is played back in the context of a scene from a pre-recorded movie such that it replaces an actor's recorded voice and/or image of the pre-recorded movie, thus giving the illusion that the user is participating in the scene. The replacement may occur in real time (without storing the user-generated audio/video information), for example as the movie is playing to an audience or to the user, or using a stored version of the user-generated content. Script notes and/or subtitles may be provided to the user so that he can better understand the scene and thereby more accurately emulate the movie character which he will personify.

U.S. Pat. No. 7,228,273 shows a voice control method that allows vocal characteristics of a character to diversely be set in a computer game where characters are capable of voice output is provided. The voice control method comprises, converting a voice that is externally input or provided in advance, based upon attribute information on the character; and an output step for outputting the converted voice as voice of the character. According to this method, the voice produced by a character that appears in a computer game can be set in accordance with the character's characteristics and various voices for each character set by each player can be created.

U.S. Pat. No. 5,752,883 discloses a computer implemented method, system and article of manufacture allows role-playing fantasy game referees to present and manage information related to a role-playing game world. The presentation of role playing game information is accomplished by using at least two collections of data sets. The first collection of data sets define the graphical appearance of objects representing elements of a role playing world. The second collection of data sets define data associated with elements of a role playing world including a level of detail. The method includes the steps of displaying objects associated with a first level of detail, and receiving a user-generated input signal representing a selection of a displayed object. The method also includes the step of identifying the game information data associated with the selected object. Finally the method includes the step of presenting role-playing game information based on the identified game information data.

The prior art describes movieoke devices that require ownership of equipment optimized for movieoke entertainment. Prior art is also more suitable to a movieoke as a game right than a role play method as a form of education or training. In addition, it requires extensive knowledge of titles and individual scenes, or it is completely unrelated to entertainment industry.

The current output from the entertainment industry is capable of creating a vast database of individual media clips. More time can be spent searching for an appropriate media clip then enjoying the movieoke experience. A simple search capability of date ranges, or actor/producer participation will not help a viewer looking to explore a particular scene or emotion.

The present invention resolves the database size issue and access issue. The size of the database is controlled by furnishing the user with a preselected set of media clips that have received an above average approval rating or are otherwise memorable. The present invention does not require an extensive knowledge of past and current titles since the contents of the database are searchable based on multiple hierarchical categories of descriptive factors, such as genres, emotions, gender, subject matter, etc. These hierarchical categories are implemented through multi-layered menus that eventually lead even the most inexperienced and uninformed user to a preferred selection. The present invention is therefore especially suitable for smaller, more intimate social gatherings, where a degree of sensitivity to others is more acute and the level of participation is especially noticeable. This is particularly true in present day cinematography, where technological advances have contributed to a rapid proliferation of movies of all kinds, making it virtually impossible to keep track of all new releases. The present invention therefore fulfills a growing, but underserved need of role play entertainment in intimate settings or in solo-play. The present invention is also capable of being played on a personal computer, a disk media player or a proprietary gaming device, and does not require expensive specialized equipment.

Due to its scalability, the present invention is also suitable for large parties and professional settings, where configurability and adaptability are especially desired. The present invention adapts to multiple hardware topographies and is configurable for multiple modes of play.

One embodiment of this invention is illustrated in the accompanying drawings and will be described in more detail herein below.

### SUMMARY OF THE INVENTION

The present invention relates to an entertainment system, in particular to a role-play video game for one, or two or more players where software accesses a machine readable media to obtain a set of preselected media clips. These preselected media clips may be scenes from a movie, a television show or a theatre play. The software then serves the chosen media clip to a display device, and plays the audio track assigned to the media clip on a sound generating device. The sound generating device can be engaged or disabled at will. Multiple categories and sub-categories are used by the software for sorting the media clips. These categories are represented by plurality multi-layered menus that are used to isolate the most desirable media clip for a user.

The present invention further relates to a method of playing a video role-play game in which at least one player directs a processing device to access a storage media having a plurality of preselected media clips. These media clips may be scenes from a movie, a television show or a theatre play. A player finds desired media clips by using a plurality of menus to access a plurality of categories. The categories lead to a subset of media clips with a common characteristic, which the player can select by using an input device. Once selected, the media clips display on a display device, which has a sound device for playing audio for the selected media clip. The media clip can be played in either the training mode or live mode, also known as the role play mode. During the live mode, the players act out the scene by reciting a performer's lines while the audio is muted.

A object of the present invention to provide an entertainment system that can be used to play preselected media clips for use in a role play game.

An additional object of the present invention is to provide an entertainment system featuring a display device, a sound system, and a means of storing and retrieving movie media clips and other binary information.

Another object of the present invention is to provide a role play system which is scalable and adaptable to various hardware layouts.

Another object of the present invention is to provide a system that is capable of playing just the video portion of the media clip.

Yet another object of the present invention is to provide a system that is capable of displaying subtitles of the lines for the players to read from during role-play.

Yet another object of the present invention is to provide an entertainment system that can be used to enliven social occasions.

Still another object of the present invention is to provide an entertainment system capable of playing on specialized hardware, or available hardware, such as a game console or a computer processing unit.

Yet another object of the present invention is to provide a role-play entertainment system for newly released DVDs to be presented as part of its special features disc.

A further object of the invention is to provide a method for promoting or advertising movies, television, or theater production using the software and method of the present invention.

Yet another object of the present invention is to provide with effective means of controlling the number of available media clips by focusing only the best media clips.

Still another object of the present invention is to provide a set of categories represented by a set of menus to quickly and efficiently find a desired media clip.

### BRIEF DESCRIPTION OF THE DRAWINGS

FIG. 1 is a flow diagram that illustrates a flow of events beginning with a user request and ending with a media clip presentation.

FIG. 2 is a block diagram illustrating a combination of hardware of the present invention.

FIG. 3 is a block diagram illustrating an alternative combination of hardware of the present invention.

FIG. 4 is a screenshot presentation showing menus and a selection tracker.

FIG. 5 is a screenshot presentation showing a sub-menu and a selection tracker.

FIG. 6 is a screenshot presentation showing a counter.

FIG. 7 is a screenshot presentation showing a role play performance with accompanying subtitles.

FIG. 8 is a detailed diagram of components of a computer system.

### DESCRIPTION OF THE PREFERRED EMBODIMENTS

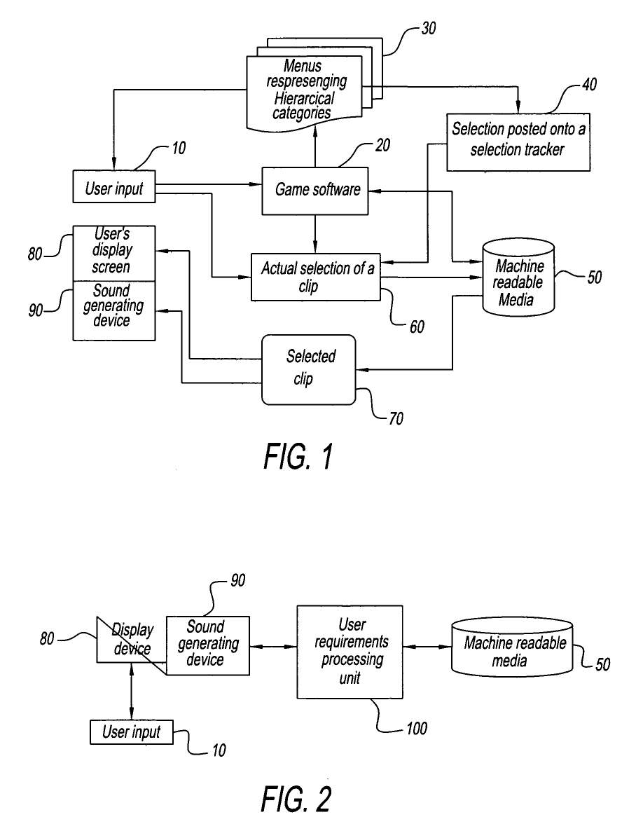

The preferred embodiments of the present invention will now be described with reference to FIG. 1-8 of the drawings. Identical elements in the various figures are identified with the same reference numerals.

The present invention is an acting entertainment media based on interactive technology that provides a prerecording of motion picture, television, and/or theatre scenes that performers act out live by viewing the scene and following the dialogue appearing on a video screen. Famous radio scripts could be used with static pictures. It is intended to be used for promotional, home entertainment and educational purposes, for young readers and adults, aspiring and professional actors, and for individual players or for groups and parties.

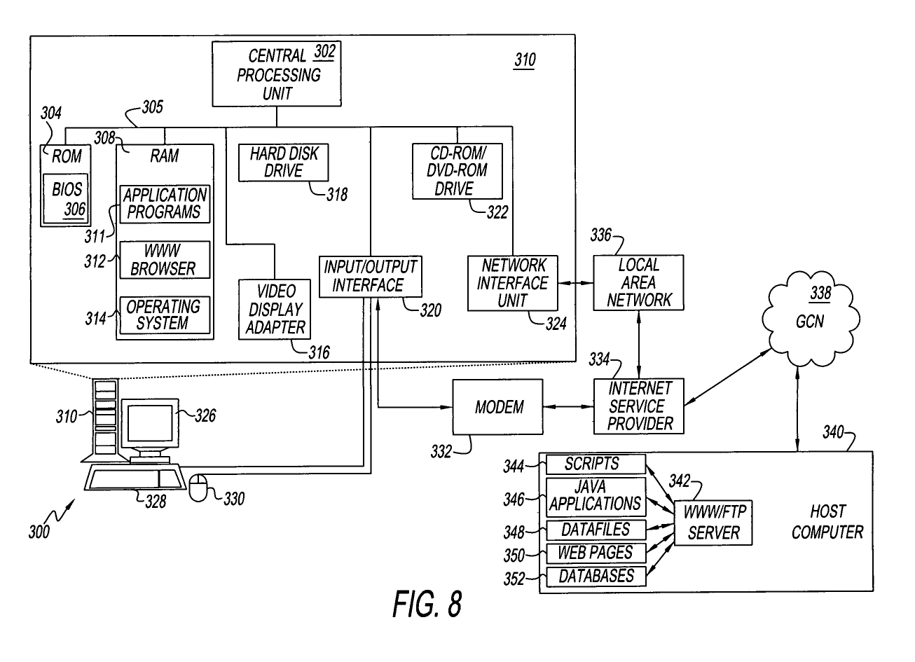

The system can be configured to work on PC's, DVD players, Apple® computers, via DVDs, flash media. It could be downloaded from the internet or played via a network or internet connection. It could be played on a game console such as Sony Playstation®, Microsoft Xbox®, or a Nintendo Wii®. The computer system capable of supporting the present invention is discussed in FIG. 8 below.

From interactive DVD menus the user will be able select/filter the role-play. The main menus will also include standard DVD features such as language and sub-title selection.

To operate the present invention, a user initiates the game software via user input. The game software presents a user with a menu. While the software is referred to herein as “game software”, it is understood that the software is used for general entertainment purposes, and may be used for entertainment where no score is kept or game played. The menu presented could be titled the main menu or the first menu or contain a plurality of other witty or informative names. In this menu a user selects a category of a desired scene. The user can select from at least one category based upon, but not limited to, gender, number of performers, media genre and/or movie genre (e.g. motion picture clips, television clips, theatre clips, comedy, drama, science fiction, fantasy, action, adventure, westerns, classics etc.) and emotions. It is important to note that different versions of the game can rely a single category or combinations of categories. So a single game might only feature westerns, another, romances, another game might include combinations, etc.

These categories can be subdivided further using additional menus. The next menu describes whether the desired scene is a dialogue or a monologue, and a subsequent menu describes for a gender of the characters. At this point, a list of preselected media clips are displayed. A description of each media clip is provided on the screen, either with text or with a descriptive icon. Once a media clip is selected, a user is again prompted with a menu to select a practice run or to go on to role play. If a practice is chosen, the media clip plays with audio and video tracks enabled.

Once the media clip is over, the user may be prompted with a menu to either select a role play, a practice run, or a different media clip. If a role play is selected, a decrementing timer is presented, and then the media clip is played with video along with subtitles, but without audio. Once the role play is done, the present invention can be directed back to the very first menu presented, and the steps can thus repeat. The combination of video, audio and subtitles is interchangeable during the game.

At any time during the game, link icons 130 are available to configure and control the flow of play. The description of menus has been simplified for the sake of clarity. In reality, there are lots of different menus that can help narrow the search to a handful of media clips. Also, menus or pages can be added to increase the entertainment value. For example, a page or menu with the words “action” and/or “cut” could be added.

The present invention is especially useful for promoting or advertising movies or other media productions. The software could also reside on a server, activated by a link associated with a movie or television advertisement located on the internet. Given the proliferation of home computers and the availability of DVD players, DVD's with the present invention could be easily mass produced and included as promotional items useful for advertising, such as new movies about to be released.

FIG. 1 is a flow diagram illustrating events and components that work in concert to enable the present invention. FIG. 1 presents a simplified overview of the system and each component will be described below. Shown in FIG. 1 are a user's input 10, software 20, menus 30, a selection tracker 40, a machine readable media 50, selection of a media clip 60, a selected media clip 70, a display device 80, a sound generating device 90, a processing device 100.

The game/entertainment responds to user's input 10, which is accomplished by using a hardware device designed to send signals though the use of electrical impulses. Input devices known in the art includes a DVD remote control, a keyboard, a pointer device, a microphone or a joystick or game controller.

A keyboard suitable for the present invention should preferably contain alphabetical letter keys to enter team and player information and search terms, arrows for navigation an escape key to terminate a screen or action, and an enter key to activate a command or proceed with to the next event or screen. A pointer device is used to move a digital pointer or a highlighter between items within the graphical presentation of a display device 80. A pointer device is able to move the digital pointer up, down and diagonally across the screen and contains at least one other key or button to notify an application of a final selection. A computer mouse is an example of a pointer device.

Joysticks and game controllers are specialized input devices that are optimized to provide a specific function, or to work with specific device or software, yet providing limited or little other functionality. Joysticks are usually used in conjunction with a game console such as Sony Playstation®, Microsoft Xbox®, or a Nintendo Wii® and various other consoles. Each manufacturer offers a joystick that is best suited for games offered with its game console. The generic nature and simplicity of the present invention enables it to be implemented by any game console manufacturer and can be used by joysticks offering navigation and selection capabilities.

Still referring to FIG. 1, the game software 20 uses interactive technology to respond to user inputs 10, to guide a user through selections and to prompt a user for the next input. The game software 20 is the processing heart of the present invention. It presents a user with a graphical interface containing hierarchical menus 30, and various link buttons 130. It is also in charge of organizing and keeping track of available media clips, as well as presenting these media clips to the user for replay. The game software 20 may use an existing third party application adapted to the present invention or be specially written using one of conventional high level languages, such as C, C++, C# or Java or in any other visual programming language that is capable of manipulating graphical objects and media files. The media clips 70 and the menus 30 are graphical objects that are managed by the game software 20. These can be written separately using the same language as the rest of the game software 20 or can be written using a different graphical language. Either way graphical objects in the present invention have logical interfaces to interact with the rest of the game software 20 and with each other.

The game software 20 also manages a library of media clips 70. The media clips are preferably stored as large files, usually media files. The media clips 70 can be stored in separate machine readable media 50 storage device, such as on a digital versatile disc (DVD), or on a separate hard drive, or on a flash card, or on any other device that is capable of storing a large amount of data within a small amount of physical space. Alternatively the media clips 70, the game software 20, and the other software and graphical components can reside on a single disc, disc device or a game cartridge. Such an all-in-one packaging is optimal and preferred, when deploying the present invention on a game console or on a personal computer, such as a PC. Flash drive storage is optimal for handheld computers, digital organizers and cellular phones. Media files may also be down loaded onto the media storage device from other sources such as the internet.

Still referring to FIG. 1, the present invention preferably contains menus 30 that represent hierarchical categories. Sorting media clips 70 by categories helps simplify the search for media clips and eliminates the need to know a precise title of the media clip being sought. The user will be able select I filter the role-play from categories based upon, but not limited to, gender, number of performers, media genre (e.g. motion picture clips, television clips, theatre clips, comedy, drama, science fiction, fantasy, action, adventure, westerns, classics etc.) and emotions. The main menus may also include standard DVD features such as language and sub-title selection.

The game and menus can be configured in any appropriate manner. In one embodiment, the media clips are accessible from a single menu. The main menu 30 of the preferred embodiment presents a user with a list of categories to choose from. A selection of a category directs the user to the next sub-menu that asks to select from a monologue or a duet, multi-party, or by actor's gender. The next sub-menu prompts for a desired emotion, such as sadness, passion, levity or anger. Eventually, the menus 30 lead the user to a desired media clip 70 or a set of media clips 70 that satisfy all users' preferences. There is an additional menu 30 for each media clip 70, where a user can specify whether the practice mode or the role play, live mode is desired. The number and subject of the categories can vary in any way that would make it easier to isolate the best media clip 70 for the taste. Menus 70 can be made configurable and an option can exist to modify an existing menu 30, or add or delete a menu 30. The idea behind the use of menus 30 is to simplify search, provide a user with a choice of most desirable media clips, and yet not make the available selection too limited or too broad. Both the menus 30 and the media clips 70 can refer to films, television shows, or theatrical performances, or any other kind of entertainment that can be presented visually or aurally and which involves a plot and actors.

The media clips 70 of the present invention are preselected. The preselected media clips offer a real advantage over the prior art. Prior art games force the users to scan the media themselves to find clips of interest. This is a time consuming process. For example, if a user were to use the prior art process at a party, they would have to scan through multiple DVD's to find appropriate clips. This is time consuming and the spontaneity of the game is lost. Even if the host were to prescreen before the party, it would take hours just to find a few clips. By “preselected” it is meant that the clips have been screened from available media beforehand to provide maximum entertainment value to the users. The prescreening could use a number of criteria. For example, a preselected media clip could be selected on the basis of gender, selected from the group consisting of male dialogue, female dialogue, male/male duet dialogue, female/female duet dialogue and male/female duet dialogue. A preselected media clip could also be selected on the basis of genre, selected from the group consisting of comedy, action, adventure, drama, or romance. A preselected media clip can also be selected based on an emotion it conveys, such as joy, anger, happiness, compassion, embarrassment, fear, horror, or sorrow. For example, the clips could be screened based on their frame or message. There are many famous scenes from movies that are memorable and could be used for clips. Media clips could also be selected from scenes that are easy to role play—for example, scenes that require extensive special effects may be less desirable because of the difficulty of reproducing the special effects during the role pay. The media clips are also selected based on the quality and entertainment of the dialogue. For example, dialogue may have comedic value and/or dramatic value.

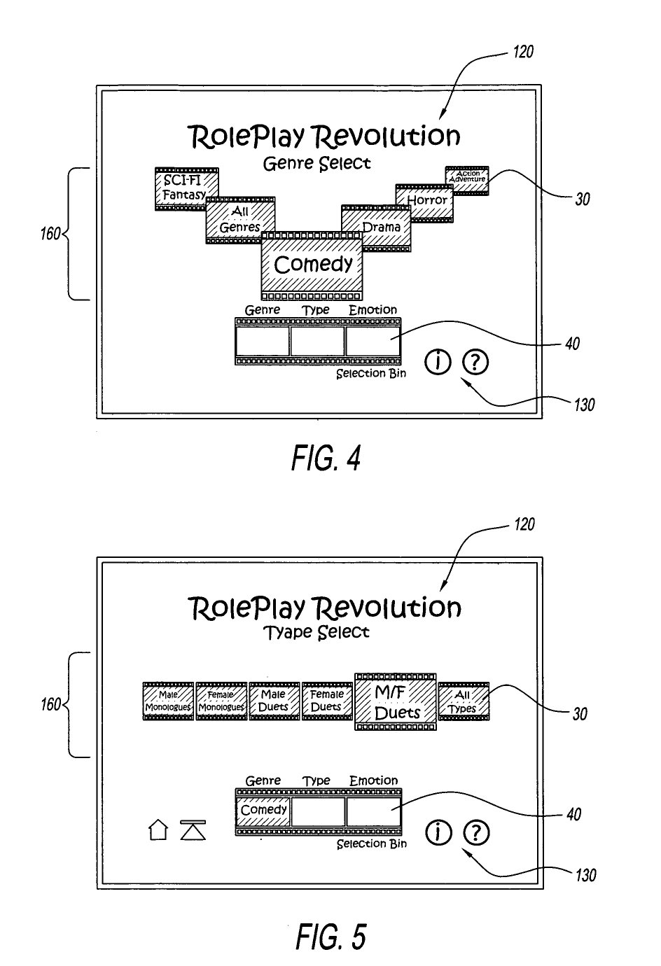

Each selection by a user gets displayed on a selection tracker 40, which will be further described in FIGS. 4 and 5 below. The selection tracker 40 provides the benefit of keeping track of the search path taken by a user and ability to alter past selections.

An actual selection 60 of a media clip 70 by a user directs the game software 20 to access the machine readable media 50. The game software 20 formats the video and audio portions of the desired media clip 70 to conform to the specifications of the user's display device 80 and the sound generating device 90. The game software 20 can keep track of user's media clip preferences and keep a set of media clips that it expects to be chosen already in cache or memory. This would save formatting time, minimize user's wait time and lengthen the life expectancy of moving parts, such as disk drives, by minimizing the number of post-selection disk reads.

Still referring to FIG. 1 the user's display device 80 and the sound generating device 90 can be a standard computer screen with speakers, or a television screen. The sound generating device 90 can be any type of sound system and can be integral with or separate from a user's display device 80 and can have a self-disabling feature. However, to maximize the utility of the present invention, the game software 20, or at least the operating system which is running the game software 20, should have internal means to disable the sound within the application. The preferred embodiment of the present invention specifies that subtitles 150 would replace the audio portion of the media clip during the actual role-play performance. However, a user will have an ability to disable or modify the presentation of the subtitles 150 on his or her display screen 160.

FIG. 2 discloses the preferred setup of the hardware required by the present invention. Shown are a machine readable media 50, a display device 80, a sound generating device 90, and a processing device 100. As mentioned above, the machine readable media 50 is any kind of storage device, either logical or physical that can be accessed by the processes described in the present invention. The specific individual user's settings of settings, preferences and intentions govern the type of media used. For large parties, or professional users, such as at trade shows, or in actor training studios, or any time portability is not desired, large disc devices can be utilized to maximize the disc space, reliability and speed of media clip presentment. For individual use, promotional or recreational use, or for small time educational use, a smaller storage device can be used, such as a DVD, or a magnetic flash card drive.

The processing device 100, is capable of running the game software 20 at adequate speed. This includes servicing user requests, displaying the graphics, playing the media clips 70 and managing the media clips 70 on the machine readable media 50. The preferred embodiment of a processing device 100 is a game console, such as Sony Playstation®, Microsoft Xbox®, or a Nintendo Wii® and various other game consoles. Another common device suitable is a personal computer. Other devices are suitable too as long as they support, or have a connection to the media reading device 50, the game software 20, and the display device 80 with the sound generating device 90.

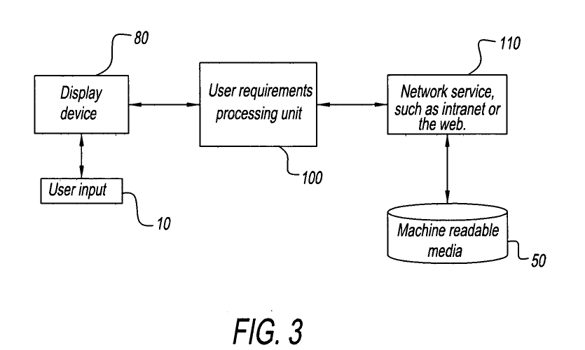

An alternative to FIG. 2 is a configuration where at least one of the hardware components is in a remote location or is shared between several users. FIG. 3 shows a machine readable media 50, a display device 80, a sound generating device 90, a processing device 100, and a network service 110. The network service 110 can be a local network which connects together the display device 80 and the processing device 100, and the machine readable media 50. The network service can also include the World Wide Web, commonly known as the internet. The game software 20 and/or the machine readable media 50 can reside somewhere remotely and be accessed by users over the internet. A network service 110 may play a major role when the present invention is used professionally, commercially or by multiple users. The network service 110 is also an optimal setup to receive upgrades and patches for the game software 100 and for the most recent media clips 70.

FIGS. 4 and 5 show a screenshot presentation of the present invention. Shown are menus 30, a selection tracker 40, a display screen 160, identifying titles 120, and link buttons 130. The menus 30 and the selection tracker 40 appear in form of segments of photographic film on an orange yellow background of the display screen 160, with identifying titles 120 in black, and with link buttons 130 of various shapes, in gold. All appearances are strictly stylistic and the colors, icon shapes, sizes and appearances of the font types and colors, all can be altered to suit requirements and tastes of the producer or the consumer.

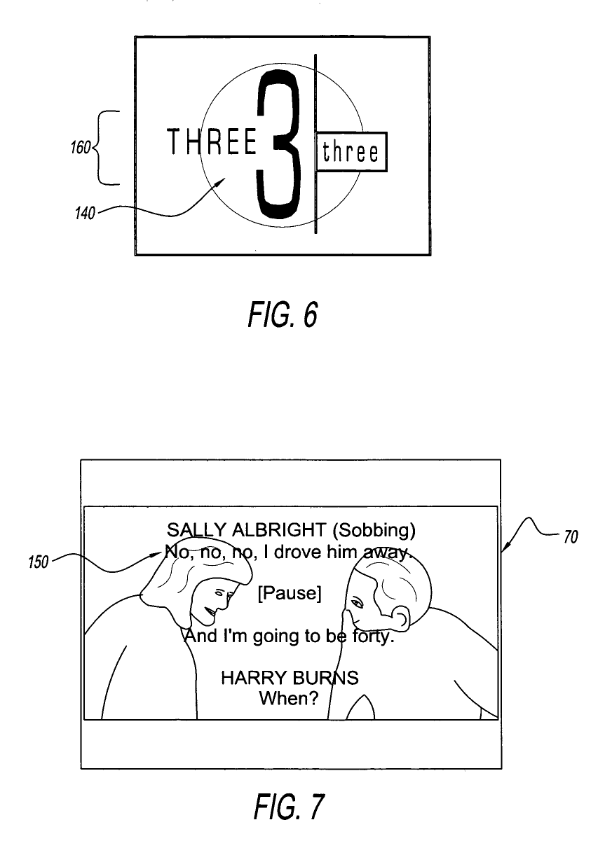

FIGS. 6 and 7 show additional attributes and feature of the present invention that get presented on the display device 80. FIG. 6 shows a counter 140. The actual appearance of the counter is not limited to the style presented and the only requirement is that the amount of time displayed by the counter is clearly shown. The counter 140 is a decrementing counter, and is used to communicate to the user how much time remains until a live role play is set to begin. At any time during the game software operation, the counter 140 can be increased, decreased, suspended or terminated. The value of the counter 140 can be adjusted internally within the game software 20. The counter 140 can also be incrementing, such as a counter displaying the value of elapsed time.

Fields in the selection tracker 40 get populated by user's selections, generally triggered with user input 10. The selection tracker 40 offers an easy means of tracking and changing selections. The selection tracker 40 is shown at the bottom of the display screen 160, with similar appearance as the menu icons 30. The selection tracker 40 is essentially an object containing status information. The status information can be shown using any other kind of an icon and be situated anywhere else with respect to the other components of the display screen 160.

The link buttons 130 are additional controls that a user can utilize to control the progress and the performance of the game software 20 and the presentation of the media clips 70. As with other functional icons, the link icons 130 are tied internally to a specific set of instructions to effectuate a change of the screen, navigation, and disk writes and reads.

FIG. 7 shows a display screen 160 during an actual role play performance. Shown is a movie media clip 70 with subtitles 150. The subtitles are designed to present the actor's lines to the user while the audio track for the media clip is muted. However, the subtitles 150 can be disabled or the audio track can be active in conjunction with the subtitles 150. In FIG. 7 the subtitles 160 appear in large letters, partially obstructing the view of the media clip 70. Alternatively, the subtitles 150 appear above or below the media clip 70, with subtitles 150 not obstructing any part of the scene being played by the media clip 70. The subtitles 150 display both the actual text of the actor's lines as well as alerts that note actor's emotional changes or pauses.

The present invention is used as a form of entertainment, as an educational and training tool for actors, or for promotional purposes. It is suited to operate in large party settings, or for individual use. It can be used remotely via a network, or on a locally attached game console or a personal computer. A user's input 10 controls the operation of the game software 20.

To operate the present invention, a user initiates the game software 20 via user input 10 into the processing device 100. The game software 20 presents a user with a menu 30. The menu presented could be titled the main menu or the first menu or contain a plurality of other witty or informative names. In this menu 30 a user selects a genre of a desired scene. Available categories include action, comedy, horror, science fiction, drama, etc. These categories can be subdivided further using additional menus 30. The next menu 30 asks whether the desired scene is a dialogue or a monologue, and a subsequent menu asks for a gender of the characters. At this point, a list of media clips 70 is displayed. A description of each media clip 70 is provided on the screen 160, either with text or with a descriptive icon. Once a media clip is selected, a user is again prompted with a menu 30 to select a practice run or to go on to role play. If a practice is chosen, the media clip 70 plays with audio and video tracks enabled. Once the media clip 70 is over, the user is once again prompted with a menu 30 to either select a role play, a practice run, or a different media clip 70. If a role play is selected, a decrementing timer 140 is presented, and then the media clip 70 is played with video along with subtitles 150, but without audio. Once the role play is done, the present invention can be directed back to the very first menu presented, and the steps can thus repeat. The combination of video, audio and subtitles 150 is interchangeable during the game.

At any time during the game, link icons 130 are available to configure and control the flow of play. The description of menus 30 has been simplified for the sake of clarity. In reality, there are lots of different menus 30 that help narrow the search to a handful of media clips 70.

At the hardware level the initialization of the game software occurs within the processing device 100, which uses internal operating system signals to respond to user input 10, to interact with the game software 20, and to access the machine readable media 50. Due to an extensive portability of the present invention, any number of hardware configurations is possible. However, if a game console is used, such a Sony Playstation®, or a personal computer, the following is an example of the physical steps necessary to implement the present invention. A user inserts a machine readable media 50 into a suitable device. The machine readable media can be a game cartridge, a flash card or a Digital Versetile Disk or any other type of portable data storing device. The readable media 50 is accessible by a processing device 100, which in the case of this example is the physical game console of the central processing unit of a personal computer. A user then navigates the menus 30 on the display device 80 to the desired media clip 70. A display device can be a computer screen or a television screen or any other device capable of displaying complex moving images. A display device 80 is used for the video part of the media clip 70, while the sound generating device 90, such as speakers, is used for the audio part of the media clip 70 Throughout the course of the game, a player may terminate the media clip 70, exit the game 20, or select a different media clip 70.

FIG. 8 and the following discussion are intended to provide a brief, general description of a suitable computing environment in which the invention may be implemented. Referring now to FIG. 8, an illustrative environment for implementing the invention includes a conventional personal computer 300, including a processing unit 302, a system memory, including read only memory (ROM) 304 and random access memory (RAM) 308, and a system bus 305 that couples the system memory to the processing unit 302. The read only memory (ROM) 304 includes a basic input/output system 306 (BIOS), containing the basic routines that help to transfer information between elements within the personal computer 300, such as during start-up. The personal computer 300 further includes a hard disk drive 318 and an optical disk drive 322, e.g., for reading a CD-ROM disk or DVD disk, or to read from or write to other optical media. The drives and their associated computer-readable media provide nonvolatile storage for the personal computer 300. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 308, including an operating system 314 and one or more application programs 310, such as a program for browsing the world-wide-web, such as WWW browser 312. Such program modules may be stored on hard disk drive 318 and loaded into RAM 308 either partially or fully for execution.

A user may enter commands and information into the personal computer 300 through a keyboard 328 and pointing device, such as a mouse 330. Other control input devices (not shown) may include a microphone, joystick, game pad, satellite dish, scanner, or the like. These and other input devices are often connected to the processing unit 300 through an input/output interface 320 that is coupled to the system bus, but may be connected by other interfaces, such as a game port, universal serial bus, or firewire port. A display monitor 326 or other type of display device is also connected to the system bus 305 via an interface, such as a video display adapter 316. In addition to the monitor, personal computers typically include other peripheral output devices (not shown), such as speakers or printers. The personal computer 300 may be capable of displaying a graphical user interface on monitor 326.

The personal computer 300 may operate in a networked environment using logical connections to one or more remote computers, such as a host computer 340. The host computer 340 may be a server, a router, a peer device or other common network node, and typically includes many or all of the elements described relative to the personal computer 300. The LAN 336 may be further connected to a global computer network (GCN or internet) service provider 334 (“ISP”) for access to the GCN 338. In this manner, WWW browser 312 may connect to host computer 340 through LAN 336, ISP 334, and the GCN 338. Such networking environments are commonplace in offices, enterprise-wide computer networks, intranets and the GCN.

When used in a LAN networking environment, the personal computer 300 is connected to the LAN 336 through a network interface unit 324. When used in a WAN networking environment, the personal computer 300 typically includes a modem 332 or other means for establishing communications through the GCN service provider 334 to the GCN. The modem 332, which may be internal or external, is connected to the system bus 305 via the input/output interface 320. It will be appreciated that the network connections shown are illustrative and other means of establishing a communications link between the computers may be used.

The operating system 314 generally controls the operation of the previously discussed personal computer 300, including input/output operations. In the illustrative operating environment, the invention is used in conjunction with Microsoft Corporation's “Windows 98” operating system and a WWW browser 312, such as Microsoft Corporation's GCN Explorer or Netscape Corporation's GCN Navigator, operating under this operating system. However, it should be understood that the invention can be implemented for use in other operating systems, such as Microsoft Corporation's “WINDOWS 3.1,” “WINDOWS 95”, “WINDOWS NT”, “WINDOWS 2000”, “WINDOWS XP” and “WINDOWS VISTA” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc. Likewise, the invention may be implemented for use with other WWW browsers known to those skilled in the art.

Host computer 340 is also connected to the GCN 338, and may contain components similar to those contained in personal computer 300 described above. Additionally, host computer 340 may execute an application program for receiving requests for WWW pages, and for serving such pages to the requestor, such as WWW server 342. According to an embodiment of the present invention, WWW server 342 may receive requests for WWW pages 350 or other documents from WWW browser 312. In response to these requests, WWW server 342 may transmit WWW pages 350 comprising hyper-text markup language (“HTML”) or other markup language files, such as active server pages, to WWW browser 312. Likewise, WWW server 342 may also transmit requested data files 348, such as graphical images or text information, to WWW browser 312. WWW server may also execute scripts 344, such as CGI or PERL scripts, to dynamically produce WWW pages 350 for transmission to WWW browser 312. WWW server 342 may also transmit scripts 344, such as a script written in JavaScript, to WWW browser 312 for execution. Similarly, WWW server 342 may transmit programs written in the Java programming language, developed by Sun Microsystems, Inc., to WWW browser 312 for execution. As will be described in more detail below, aspects of the present invention may be embodied in application programs executed by host computer 342, such as scripts 344, or may be embodied in application programs executed by computer 300, such as Java applications 346. Those skilled in the art will also appreciate that aspects of the invention may also be embodied in a stand-alone application program.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. An entertainment system for use by at least one player comprising:
a software;
a processing device for interpreting instructions given by said software;
a machine readable media for storing a set of preselected set of media clips;
a display device for viewing said media clips;
a sound generating device for selectively listening to an audio track of said media clips;
at least one category for sorting said media clips; and
at least one menu used for locating said media clips using said at least one category on said storage media.

2. The system of claim 1, further comprising a counter, said counter specifies a readiness countdown to a user of said system.

3. The system of claim 1, wherein said processing device is a proprietary gaming system.

4. The system of claim 1, wherein said processing device is a central processing unit of a computer.

5. The system of claim 1, where in said processing device is a digital video disk player.

6. The system of claim 1, wherein the machine readable media is a DVD.

7. The system of claim 1, wherein the machine readable media is a computer hard disk.

8. The system of claim 1, wherein the display device is a television screen.

9. The system of claim 1, wherein the display device is a computer screen.

10. The system of claim 1, wherein said categories are comprised of a plurality of categories, character gender and age, number of performers, and a list of emotions.

11. The system of claim 1, wherein said media clips are selected for the storage media based on said media clip's frame or profound message.

12. The system of claim 1, wherein the system judges the users effectiveness at replicating the media clip.

13. The system of claim 1, wherein the system is used as a special feature, or to promote a movie television show, theater production or radio show.

14. The system of claim 1, wherein the set of media clips is from a movie, television show, theater production, radio show or combinations thereof.

15. A method of playing a video role-play game comprising:
at least one player;
said player directing a processing device to access a storage media having a plurality of preselected media clips, said media clips are assigned to a plurality of categories;
said categories are accessed by a plurality of menus;
said display device capable of interpreting and displaying the contents of said storage media;
said display device having an input device used for browsing said categories and for selecting media clips;
said input device capable of to playing said media clip in a training mode and in a live mode; and
said players using said method to view said media clips and act out an audio portion of said media clip.

16. The method of claim 15, wherein said live mode is preceded by a counter, which displays a countdown to a time when said live mode gets activated.

17. The method of claim 15, wherein said input device causes said menus to browse said categories that are comprised of a plurality of categories, character age, character gender, number of performers, and a list of emotions.

18. The method of claim 15, wherein said live mode is triggers said display device to disable the audio portion of said media clip.

19. The method of claim 15, wherein said input device triggers said display device to produce subtitle material having said player's lines and emotions.

20. The method of claim 15, wherein said media clips are selected on their frame in a viewing community.
